(19) United States
(12) Patent Application Publication
(10) Pub. No.: US 2026/0211600 A1
(43) Pub. Date: Jul. 23, 2026

(54) INDUSTRIAL PRINTING SYSTEM, MANAGEMENT SERVER, AND PROCESSING MANAGEMENT METHOD FOR EFFICIENTLY SCHEDULING A GROUP JOB

(71) Applicant: KYOCERA Document Solutions Inc., Osaka (JP)

(72) Inventor: Taku MATSUO, Los Angeles, CA (US)

(73) Assignee: KYOCERA Document Solutions Inc., Osaka (JP)

(21) Appl. No.: 19/026,382

(22) Filed: Jan. 17, 2025

(51) Int. Cl. G06F 3/12

(52) U.S. Cl. CPC G06F 3/1262; G06F 3/1203; G06F 3/1263; G06F 3/1282

(57) ABSTRACT

Provided is an industrial printing system that efficiently processes jobs in groups. The schedule management unit centrally manages the schedule setting for processing jobs in component apparatuses. The Group Management Section generates group jobs that summarize jobs according to generation rule that indicate how to summarize jobs, and performs simulation to assign group jobs to available schedule setting. The processing management unit makes the corresponding component apparatus process the generated group jobs according to the simulation result.

### BACKGROUND

In particular, the present disclosure relates to an industrial printing system, a management server, and a processing management method that performs industrial printing (production printing).

In industrial printing, known as production printing, which uses commercial (industrial) printing apparatus, the components of the final product are produced by dividing the work among a plurality of processes. For example, in the case of bookbinding, the cover, body (color), body (black and white), promotional materials, belt, and shipping envelope are processed as different jobs. The jobs are then combined in intermediate processes to produce the final product, the book.

In these production printing systems, the plurality of jobs that perform the same process are managed by a batch management server, and a large number of print jobs may be evenly distributed and processed.

A typical technology disclosed is an industrial printing system that processes production printing in a peer-to-peer distributed manner. This industrial printing system performs production printing and has the plurality of site servers. The plurality of site servers process print jobs in a distributed manner. Each site server is provided with a storage unit, a processing determination unit, and a processing management unit. The storage unit stores a capacity table that indicates the capacity that can be processed by printing and post-processing. The processing determination unit determines other site servers that can process jobs among the plurality of site servers based on the capacity table stored in the storage unit. The processing management unit sets a schedule for processing jobs by other site servers that are determined to be processable by the processing determination unit, and it sends the jobs to the other site servers for processing according to the schedule setting.

### SUMMARY

An industrial printing system of the present disclosure is an industrial printing system that performs production printing, including: a schedule management unit that centrally manages schedule setting for processing jobs on component apparatuses; a group management unit that generates a group job by grouping jobs in accordance with a generation rule that indicates how to group jobs and performs a simulation of allocating the group job to an available space in a schedule setting managed by the schedule management unit; and a processing management unit that causes a corresponding component apparatus to process the group job generated according to result of the simulation performed by the group management unit.

A management server of the present disclosure is management server that manages jobs for component apparatuses in an industrial printing system that performs production printing, including: a schedule management unit that centrally manages schedule setting for processing of jobs on component apparatuses; a group management unit that generates a group job by grouping jobs in accordance with a generation rule that indicates how to group jobs and performs a simulation of allocating the group job to an available space in a schedule setting managed by the schedule management unit; and a processing management unit that causes a corresponding component apparatus to process the group job generated according to result of the simulation performed by the group management unit.

A processing management method of the present disclosure is a processing management method executed by a management server that manages jobs of component apparatuses in an industrial printing system that performs production printing, including the steps of: centrally managing schedule setting for processing of jobs on component apparatuses; generating a group job by grouping the jobs in accordance with a generation rule that indicates how to group jobs; performing a simulation of allocating the group job to an available space in the managed schedule setting; causing the corresponding component apparatus to process the generated group job according to the results of the simulation.

### BRIEF DESCRIPTION OF THE DRAWINGS

FIG. 1 is an example of a system configuration diagram of an industrial printing system according to the present disclosure;

FIG. 2 is a block diagram of a control configuration of the management server as shown in FIG. 1.

FIG. 3 is a block diagram showing a functional configuration of the management server as shown in FIG. 1.

FIG. 4 is a block diagram showing details of the job as shown in FIG. 3.

FIG. 5 is a block diagram showing the details of the generation rule as shown in FIG. 3.

FIG. 6 is a flowchart of the group allocation process; and

FIG. 7 is a conceptual diagram of the group allocation process as shown in FIG. 6.

### DETAILED DESCRIPTION

### Embodiment

### Configuration of Industrial Printing System X

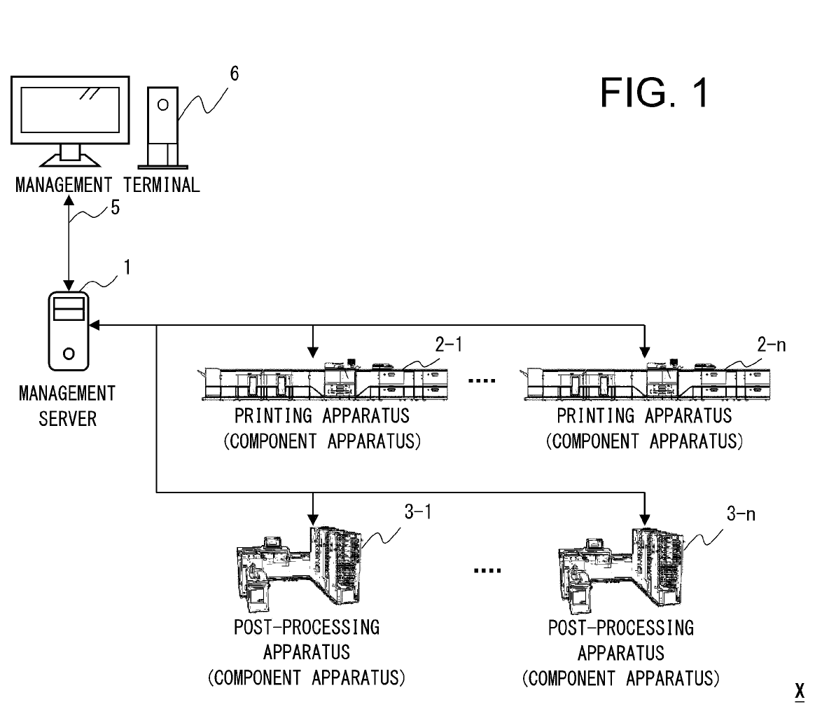

Firstly, with reference to FIG. 1, an example of the overall system configuration of the industrial printing system X according to the present embodiment is described.

The industrial printing system X according to the present embodiment manages a workflow of output by a printing process and a post-processing process (hereinafter simply referred to as “printing”) in industrial printing (production printing).

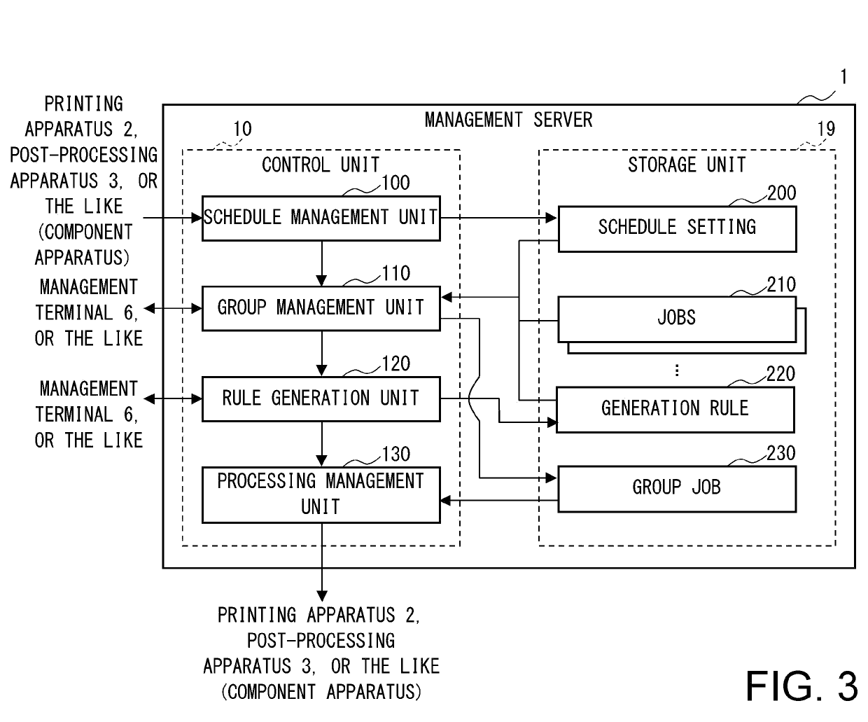

In the industrial printing system X, the final product, such as a book to be output, is referred to as an “order,” and each component of an order is referred to as a jobs 210 (FIG. 3).

The industrial printing system X is provided at a site of printing company, printing plant, or the like.

In the industrial printing system X, the management server 1 manages printing-related apparatuses including printing apparatuses 2-1 to 2-n, post-processing apparatuses 3-1 to 3-n, and the like (hereinafter referred to as a “component apparatuses”). The management server 1 is also connected with a management terminal 6, which is used by the administrator or other users of the industrial printing system X, via network 5.

Hereinafter, when any one of the printing apparatuses 2-1 to 2-n is indicated, it is simply referred to as a printing apparatus 2. Similarly, when referring to any one of the post-processing apparatuses 3-1 to 3-n, it is simply referred to as a post-processing apparatus 3.

The management Server 1 is an information processing apparatus that serves as a print controller or digital front e (DFE), which manages and controls the component apparatuses. The management server 1 is configured with a PC (Personal Computer), a server, a dedicated apparatus, general-purpose machine, or the like. In the present embodiment, the management server 1 allocates the processing of a jobs 210 to each component apparatus and causes it to perform the processing according to the schedule.

In the present embodiment, the management server 1 sends and receives various instructions and information to and from the printing apparatus 2 and post-processing apparatus 3 in production printing. Thus, the management server 1 manages the status of each apparatus and requests the processing of jobs 210.

Further, in the present embodiment, the management server 1 executes dedicated print management (order output management) application software (hereinafter simply referred to as “application”) and thus manages and grouping the jobs 210 (FIG. 3). The print management application (hereinafter referred to as the “dedicated application”) may be executed on a common platform. On this common platform, print design creation, user management, tenant management, security management, maintenance notification services, prepress process management, storage management of each document, management of the printing apparatus 2, or the like, may be executed.

The printing apparatus 2 is an industrial printer, automated offset printing apparatus, digital printer, MFP (Multi-Functional Peripheral), or the like. The printing apparatus 2 is capable of executing printing processes such as small-lot printing or large-volume (multi-lot) offset printing.

Each of the printing apparatuses 2 according to the present embodiment may differ in the size, paper quality, color profile, recordable range, or the like, for the recording paper used in the printing process.

The post-processing apparatus 3 is an apparatus capable of executing processing after printing (post-processing) such as folding, collating, binding, cutting, binding, or the like, for recording paper printed by printing apparatus 2.

Each of the post-processing apparatus 3 according to the present embodiment may also differ in terms of the method, range, or the like, for the processing that can be performed in the post-processing process.

The network 5 may be a local area network (LAN), wireless LAN (Wi-Fi), wide area network (WAN), cellular phone network, industrial network, voice telephone network, other dedicated line, or the like. The network 5 can send and receive various commands and data to and from each apparatus. Furthermore, the management server 1 and each component apparatus may also be connected to each other via LAN or other intra-base networks among Network 5. In addition, the network 5 may be set up as a virtual private network (VPN), or the like.

Management terminal 6 is an information processing apparatus such as a PC, a smartphone, a tablet terminal, a personal data assistant (PDA), dedicated terminal, or the like. The management terminal 6 is used by the administrator or other users to control printing. In the present embodiment, the management terminal 6 executes the dedicated application to set up and instruct a simulation, set up generation rule 220 (FIG. 3), check costs, or the like.

In addition, the management terminal 6 can also execute an application to control the design and prepress of production printing. Further, for this design and prepress, the management terminal 6 may be connected with the other terminals for submission, design proofing, and the like. Furthermore, the management terminal 6 may be provided with the function of a management apparatus that generates the jobs 210 and manages the processing requests of each apparatus by the management server 1. This makes it possible to acquire the jobs 210, design and submit prints, manage prepress processing, perform progress status checks and processing requests, and the like.

Note that there may be the plurality of of these apparatuses depending on the application, scale of printing, or the like. The other component apparatuses managed by the management server 1 may also be provided. The other component apparatuses include, for example, a terminal for submission, a terminal for design proofing, prepress equipment, and the like.

Also, in addition to the management server 1, the system may also be provided with a shipping management server that manages the shipping of orders sent after printing or post-processing has been completed, a server for a system upstream of the management server 1, and the like. In addition, another general terminal used by a user may be connected with the network 5. The general terminal may include a so-called console.

This allows the management server 1 to be accessed by a user at the management terminal 6 or at a general terminal by using a web browser, a terminal, the dedicated application, or the like. Thus, the user can obtain the jobs 210, assign it to a group, design and submit prints, manage prepress processing, check progress and request processing, or the like.

### Control Configuration of Management Server 1

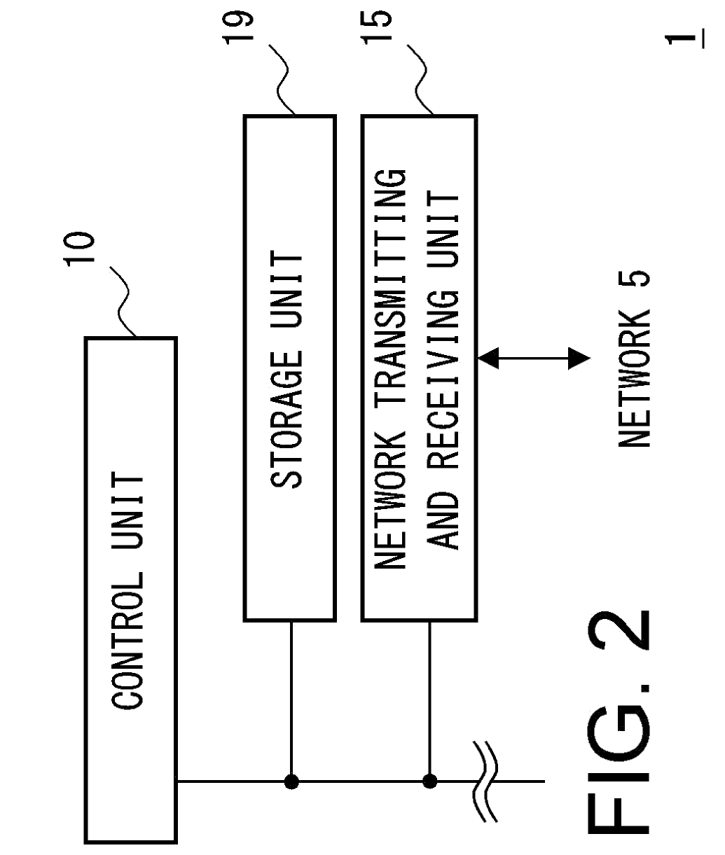

Then, with reference to FIG. 2, the control configuration of Management Server 1 is described.

The management server 1 includes a control unit 10, a network transmitting and receiving unit 15, and a storage unit 19. Each part is connected to the control unit 10 and its operation is controlled by the control unit 10.

The control unit 10 is an information processing unit such as general purpose processor (GPP), a central processing unit (CPU), a micro processing unit (MPU), a digital signal processor (DSP), a graphics processing unit (GPU), a neural processing unit (NPU), an application specific integrated circuit (ASIC), a processor for specific applications, or the like.

The control unit 10 is made to operate as each of the functional blocks as described later by reading a control program stored in the ROM or HDD in the storage unit 19, expanding the control program into the RAM, and executing it. The control unit 10 also controls the entire apparatus according to the instruction information input from the management terminal 6 or the general terminal.

The network transmitting and receiving unit 15 is a network connection unit that includes a LAN board, wireless transmitting and receiving unit, or the like, for connecting with network 5.

The network transmitting and receiving part 15 transmits and receives data on data communication lines and voice signals on voice telephone lines.

The storage unit 19 is a non-transitory recording medium. The storage unit 19 includes semiconductor memory such as ROM (Read Only Memory) and RAM (Random Access Memory), magnetic storage such as HDD (Hard Disk Drive), or the like.

The ROM and HDD in storage unit 19 store a control program for controlling the operation of the management server 1. This control program includes the operating system (OS), middleware on the OS, services (daemons), various applications, database data, and the like. The various applications include the printing process management application as described above.

In the present embodiment, the storage unit 19 may store program and data for the process of raster-in-process (hereinafter abbreviated as “rasterize” or “RIP”), which converts vector (line drawing) image data into raster data (pixel image data for printing). The programs and data for this rasterization process also include commercial libraries, fonts, or the like. In addition, the storage unit 19 also stores information, control programs, or the like, for the connected component apparatuses.

In addition, the storage unit 19 may also store account setting, other data, or the like, for users of the industrial printing system X.

In addition, in the management server 1, the control unit 10 may be integrally formed as a CPU having a built-in GPU, a chip-on-module package, a system on a chip (SOC), or the like.

The control unit 10 may also have a built-in RAM, ROM, flash memory, or the like.

### Functional Configuration of Management Server 1

Here, with referring to FIG. 3, a functional configuration of the management server 1 is described.

The control unit 10 in the management server 1 provides a schedule management unit 100, a group management unit 110, a rule generation unit 120, and a processing management unit 130.

The storage unit 19 stores a schedule setting 200, jobs 210, generation rule 220, and a group job 230.

The schedule management unit 100 centrally manages the schedule setting 200 for the processing of jobs 210 on component apparatuses. In the present embodiment, the schedule management unit 100 manages the schedules for the processing of the printing apparatus 2 and post-processing apparatus 3 as the schedule setting 200.

The group management unit 110 generates a group job 230, which is a group of jobs 210, according to the generation rule 220. The group management unit 110 then performs a simulation of allocating the group job 230 to the available space in the schedule setting 200.

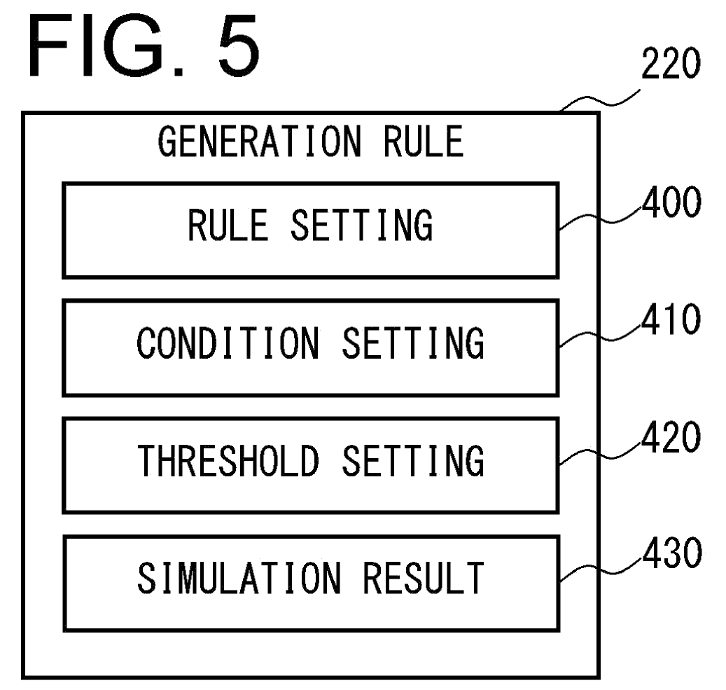

At this time, the group management unit 110 performs the simulation based on the condition setting 410 (FIG. 5), which gives priority to the delivery date information 310 or cost, and the delivery date information 310. The group management unit 110 may then output the result of this simulation.

The rule generation unit 120 generates the generation rule 220 based on either or both the processing capacity and status of the component apparatuses.

Specifically, the rule generation unit 120 is capable of generating the generation rule 220 according to the processing capabilities of each component apparatus, such as rules according to the capabilities of color processing, spot colors, and post-processing, the type of paper set as the status, and combinations thereof.

The processing management unit 130 causes the generated group job 230 to be processed by the corresponding component apparatus according to the simulation result 430 (FIG. 5) by the group management unit 110.

The processing management unit 130 allocates the group job 230 to the component apparatuses when the set time, set interval, or the number of jobs 210 obtained reaches the set value.

Furthermore, the processing management unit 130 may send the jobs 210 themselves, data processed by the jobs 210, and processing status and completion notifications to the management terminal 6 to manage the processing of the jobs 210 according to the dedicated application setting.

The schedule setting 200 is configuration information that indicates the schedule status regarding the execution of each the jobs 210. The schedule setting 200 includes, in chronological order, the processing schedule (allocation) or availability of the jobs 210, the processing status (status), the operating status, and the dispatch record of the jobs 210 for each ID (Identification) of the component apparatus. Among these, the dispatch record is information related to the physical dispatch of printed materials after printing and may include, for example, information such as printing completion time, dispatch time, receipt time, and the like.

In addition, in the present embodiment, the generation rule 220 may include information on the processing capabilities and status information of each component apparatus. This information on the processing capabilities of the component apparatus may include information on the capabilities that can be processed in rasterization, printing, and post-processing, as well as the processing time and output speed (hereinafter referred to as “throughput”). The status information may be information on paper and consumables set up, operating status, maintenance, or the like.

The jobs 210 is production print job(s), and each of them is collection of various data used in printing. The jobs 210 may be described, for example, in JDF (Job Description Format) and/or JMF (Job Messaging Format).

The details of the jobs 210 are described later.

The generation rule 220 is configuration data including setting, various conditions, and threshold values for generating the group job 230.

The details of the generation rule 220 are also described later.

The group job 230 is data that groups one or the plurality of of the jobs 210. The group job 230 may include not the jobs 210 themselves, but the IDs, or the like, of each of the grouped jobs 210, as well as the time and component apparatus IDs, or the like, to be allocated on the schedule setting 200. Further, the group job 230 may be set to the expected time of processing completion output at the time of simulation.

### Details of jobs 210

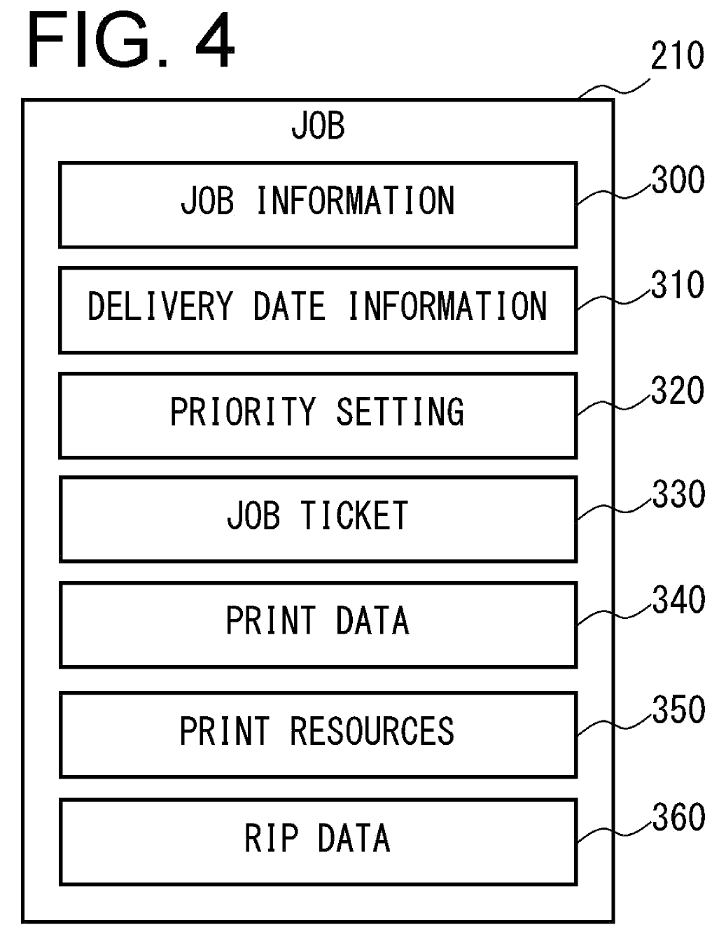

Next, with referring to FIG. 4, details of one of the jobs 210 (the job 210) is described.

In the present embodiment, the data used in the jobs 210, mainly for rasterization, printing, and post-processing, is to be described.

The job 210 includes, for example, job information 300, delivery date information 310, priority setting 320, job ticket 330, print data 340, and print resources 350, and the like (these are also hereinafter referred to as “data content”). The jobs 210 may also include RIP data 360 as the data content depending on the type of job.

The job information 300 is data that includes attributes specified in the printing process (hereinafter referred to as “specified attributes”). As the specified attributes, the job information 300 is set the type of the job 210, the name of the job 210, the name of the project (order), the designation of printing apparatus 2 or post-processing apparatus 3, the number of copies and whether collating is performed or not, whether recording is performed or not, the number of mm for cutting, the printing direction, the printing status, the priority order, or the like. The types of the job 210 include a job for rasterization processing (a rasterization job), a job for printing processing (a printing job), or a job for post-processing (a post-processing job).

The delivery date information 310 is information on the delivery date of the job 210. This delivery date information can be set to one or more of various delivery time information, such as delivery date and time, desired completion date and time, and the like.

Among these, the delivery date and time is the date and time specified by the user or upstream system as the absolute deadline date and time of delivery when the processing must be completed. The desired completion date and time is the date and time when completion is desired for the job delivery date. As described later, this desired completion date and time may correspond to the threshold setting 420 of the generation rule 220 when the simulation is performed.

Further, the delivery date information 310 may also include information on the estimated processing completion time output at the time of simulation.

The priority setting 320 is setting information whether the delivery date of the delivery date information 310 is prioritized or the cost of the processing is prioritized. Further, the priority setting 320 may also include setting for priorities related to the output of the job 210, such as the type of component apparatus at the output of the jobs 210, the type of paper, the type of post-processing, and the like.

Furthermore, the priority setting 320 may include reservation information to specify the printing apparatus 2 or post-processing apparatus 3. This reservation information may correspond to the group job 230 as described above.

The job ticket 330 is configuration data that includes print instruction attributes for requesting the job 210. The job ticket 330 includes, as print instruction attributes, lower-level settings in the workflow, which are order settings. These may be settings required in the printing process and post-processing process, such as color mode, imposition, paper, and binding, and the like.

The job ticket 330 may also be described in JDF and/or JMF.

The print data 340 is data of a printed manuscript with a design set according to the order. The print data 340 may be, for example, electronic document data such as portable document format (PDF), post script (PS) data, and the like, other vector data, data in a format for submission, other raster image data, or the like.

The print resources 350 are information on various resources necessary for printing instructions, such as color modes, fonts, and the like. These various resources may be referenced in the generation rule 220.

The other resource data necessary for printing may also be included in the print resource 350.

The RIP data 360 is data such as PDF, or the like, containing image data, which has been rasterized based on the job ticket 330. This image data may be, for example, TIFF or other bitmap data. Further, the image data may be lossless or irreversibly compressed.

Additionally, the jobs 210 may contain information such as schedule change information, record information of processing changes when actually processed, other information, and the like.

### Details of Generation Rule 220

Next, with referring to FIG. 5, the details of the generation rule 220 is described.

In the present embodiment, the generation rule 220 include, for example, rule setting 400, condition setting 410, threshold setting 420, simulation result 430, and the like.

The rule setting 400 is configuration data that indicates how group jobs 230 are grouped. For example, the rule setting 400 can be set in script language, macro language, or the like, with rules based on either or both the processing capability and state of the component apparatuses. Furthermore, the rule setting 400 can also set rules such as allocating the generated group job 230 to the free schedule that can process it the fastest or allocating the group job 230 that can process the most jobs 210 to the free schedule.

Specifically, the rule setting 400 may be a setting that groups the appropriate jobs 210 together to the group job 230 according to the processing capabilities and/or status of the component apparatuses. For example, the rule setting 400 may be set up with respect to color processing, a rule that assigns the printing apparatus 2 for color printing or the printing apparatus 2 for monochrome printing. In such case, the rule setting 400 may be a rule, as regarded special color printing process, for assigning the plurality of jobs 210 to a printing apparatus 2, which only prints normal color of cyan, magenta, yellow, and key plate (CMYK), or a printing apparatus 2, which can print special colors with color specifications other than CMYK (hereinafter referred to as “+alpha colors”). Specifically, the +alpha colors include colors other than CMYK such as white, transparent, gold, silver, pink, hologram printing, and the like.

Also, the rule setting 400 may be a rule with respect to the color profile for grouping the plurality of jobs 210 into the printing apparatus 2 that provides with a specific ICC profile or the printing apparatus 2 that does not provide with the specific ICC profile.

Also, the rule setting 400 may also be a rule with respect to the processing-enable print paper (support paper), ink, resolution, or the like, for grouping the plurality of jobs 210 into the printing apparatuses 2 that support a particular paper, ink, resolution, or the like, and the printing apparatus 2 that does not support the particular paper, ink, resolution, or the like.

Also, the rule setting 400 may be a rule with respect to post-processing for grouping the plurality of jobs 210 into the post-processing apparatus 3, which is capable of a particular finishing process, or the post-processing apparatus 3, which is not capable of the process.

Furthermore, the rule setting 400 may be a rule that groups the plurality of jobs 210 according to the availability of a commercial library for color designation. These commercial libraries include PANTONE® HKS, DIC®, TOYO®, or the like. In the present embodiment, the setting including color profile and spot color information is referred to as the “color mode.”

Also, the rule setting 400 may be a rule to group the plurality of jobs 210 by the availability of fonts that can be used.

Also, the rule setting 400 may also be a rule that groups together the plurality of jobs 210 by, for example, the processing capability of RIP at the management server 1, the presence or absence of processing of image enhancement, skew correction, and the like, and the presence or absence of plug-ins, or the like. The plug-ins may be those that perform processing of imposition, preflight and preflight profiles, or the like.

Also, the rule setting 400 may be a rule that groups the plurality of jobs 210 together by throughput. This throughput may be set, for example, by a value such as the average number of pages per minute (PPM), which is processing per minute.

The condition setting 410 includes a set value of conditions for starting the simulation. The set value of this condition may be any condition based on one or any combination of the set time, set interval, and number of the jobs 210 acquired. The set value of the condition may be configurable by the user via dedicated application, or the like. More specifically, the set value of the condition may be, for example, an initial value obtained when the component apparatus is installed and a specific degree of processing is performed. Otherwise, the set value of the condition may be any time set by the user. Alternatively, the set value of the condition may be a time interval set by the user. Alternatively, the set value of the condition may be the timing when the number of jobs 210 stored in the storage unit 19 reaches the number specified by the user.

Further, in the present embodiment, the condition setting 410 includes a setting for the condition of whether priority is given to the delivery date information 310 in the jobs 210 or the cost when assigning the group jobs 230. The condition setting 410 may also include setting for a condition such as whether to apply, prioritize, or not apply the priority setting 320 in the jobs 210, or the like.

The user can set these conditions of the condition setting 410 on the dedicated application.

The threshold setting 420 is the setting of the conditions for starting execution of the group job 230. In the present embodiment, the threshold setting 420 includes a setting indicating the threshold condition for the completion processing time of the group job 230. Specifically, the threshold setting 420 is referenced when the allocation of the group job 230 actually starts. More specifically, the threshold setting 420 can set threshold conditions for each job 210, such as the earliest time among the estimated processing completion times being the first to exceed the threshold date and time, or the latest time among the estimated processing completion times being the first to exceed the threshold date and time. The threshold date and time can be set by the user to a time period such as hours to days. Further, the threshold setting 420 may be referenced during simulation.

The simulation result 430 are data of the result of the simulation by the processing management unit 130. The simulation result 430 may be, for example, for example, the estimated processing completion time of each job 210, the estimated processing completion time of the entire group job 230, and the overall cost including the amount of consumables and expenses. In this case, the simulation result 430 may include the plurality of results when each group job 230 is assigned based on the schedule information. The simulation result 430 may be viewable on a dedicated application.

In the present embodiment, the simulation result 430 may also include estimate data.

The estimate data may be an estimate data for processing the jobs 210 belonging to the group job 230 in the time that the group job 230 is generated. For example, the estimate data may include an estimate of printing and post-processing time, an estimate of the amount of consumables such as ink and paper, and other cost estimates.

In addition, the generation rule 220 may also include alternative setting for capabilities and setting states that can be substituted. For example, the alternative setting may or may not be substitutable for a color mode, a font, or the like. Furthermore, the alternative setting may include a setting as to what extent alternatives are permitted if alternatives are possible.

In the present embodiment, the generation rule 220 may be set by the user in the dedicated application.

Here, the control unit 10 of the management server 1 is made to function as the schedule management unit 100, the group management unit 110, the rule generation unit 120, and the processing management unit 130 by executing the control program stored in the storage unit 19.

The components of the management server 1 described above are hardware resources that execute the processing management method according to the present disclosure.

Some or any combination of the functional configurations described above may be configured hardware or circuitry by means of ICs, programmable logic, field-programmable gate array (FPGA), or the like.

### Group Allocation Process by Management Server 1

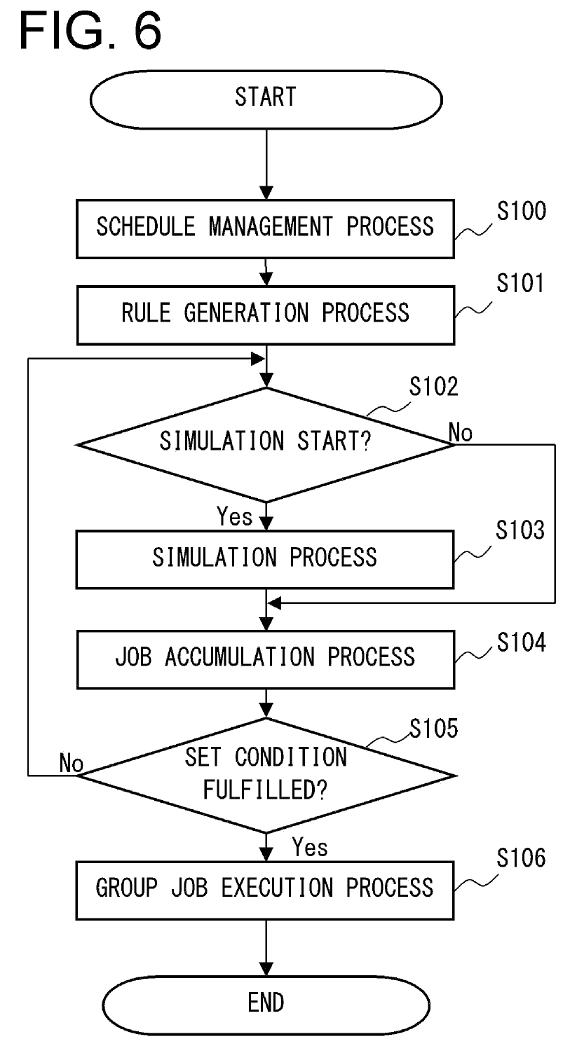

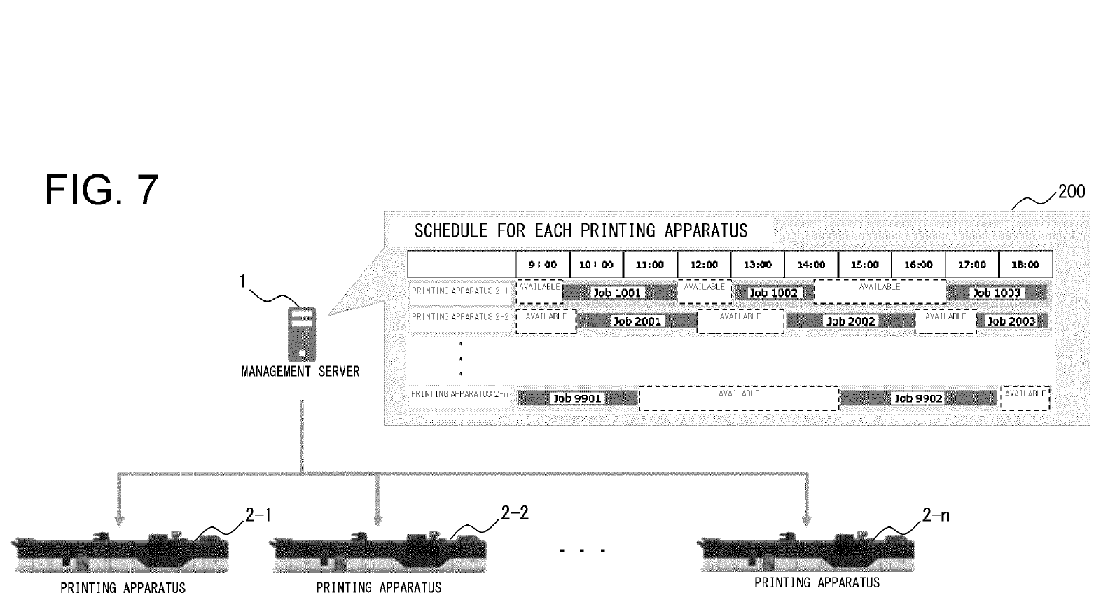

Next, with reference to FIGS. 6 to 7, a group allocation process by the management server 1 according to the present embodiment is described.

In the group allocation process according to the present embodiment, the schedule setting 200 for processing the jobs 210 are centrally managed. On this basis, a group job 230 that is grouped the jobs 210 is generated according to the generation rule 220 that indicates how to group the jobs. Then, simulation of the allocation of the group job 230 to the available space in the managed schedule setting 200 is performed. The generated group jobs 230 are then processed by the corresponding component apparatuses according to the results of the simulation.

In this group allocation process, the control unit 10 of the management server 1 mainly executes the program stored in the storage unit 19 in cooperation with the various units and using hardware resources.

With reference to the flowchart in FIG. 6, the details of the group allocation process are explained step by step below.

Step S100

Firstly, the schedule management unit 100 performs the schedule management process.

The schedule management unit 100 centrally manages schedules for processing the jobs 210 on component apparatuses by using schedule setting 200.

In the present embodiment, the printing apparatus 2 and post-processing apparatus 3 (component apparatuses) managed and connected with the management server 1 share the schedule setting 200 for the processing of jobs 210 throughout the industrial printing system X. Therefore, the schedule management unit 100 connects to each component apparatus and grasps the processing status and completion status each of the jobs 210. Thus, the schedule management unit 100 makes this status reflect in the schedule setting 200 and updates it in real time. This enables the schedule management unit 100 to centrally manage the available schedule of each component apparatus in the schedule setting 200.

Further, the schedule management unit 100 acquires information on processing capacity and status from each component apparatus as appropriate, and it sets this information in the schedule setting 200.

Step S100

Then, the rule generation unit 120 performs the rule generation process.

Here, the rule generation unit 120 generates the generation rule 220 for the group job 230 according to the processing capability or setting of the component apparatus.

In the present application, the rule generation unit 120 generates rule setting 400 according to the processing capability of the component apparatus. For example, the rule generation unit 120 generates the rule setting 400 according to the color processing type in the printing apparatus 2, post-processing type in the post-processing apparatus 3, or the like.

Otherwise, the rule generation unit 120 generates the rule setting 400 according to the status of the component apparatus. For example, the rule generation unit 120 generates the rule setting 400 according to the paper, or the like, set in the printing apparatus 2.

Alternatively, the rule generation unit 120 can generate the rule that combines the processing capability and the status of the component apparatus.

Here, the rule generation unit 120 can also, for example, show the generated rule setting 400 to the user for one of the selection candidates of setting by graphical user interface (GUI) in the dedicated application on the management terminal 6 and let them select one.

Furthermore, the rule generation unit 120 can also generate the most suitable rule setting 400 from a plurality of jobs 210, which has already been stored in the storage unit 19.

In the present embodiment, the rule generation unit 120 analyzes the job ticket 330 and content information for each of the jobs 210. From the results of this analysis, the rule generation unit 120 can use artificial intelligence (AI) or heuristics to estimate the optimal conditions for combining the plurality of jobs 210 as a group job 230 and generate the rule setting 400.

For example, the rule generation unit 120 may generate the generation rule 220 by referring to the job ticket 330 in each of the jobs 210. The rule generation unit 120 can generate the rule setting 400 by referring to the color processing designation, paper designation, and finishing process designation as print instruction attributes in the job ticket 330.

Alternatively, the rule generation unit 120 can perform a preflight check if the jobs 210 is a PDF, or the like, extract attributes such as a specified color profile, and generate a rule setting 400 based on these.

Alternatively, the rule generation unit 120 can generate the color designation as the rule setting 400 if a plurality of jobs 210 collectively include color and monochrome print jobs 210. Conversely, the rule generation unit 120 does not generate the rule setting 400 for the color designation if all of the plurality of jobs 210 are color printing jobs or all are monochrome printing jobs.

Alternatively, if the plurality of jobs 210 collectively include 210 CMYK color jobs and CMYK +alpha color jobs 210, this can be generated as the rule setting 400. Conversely, if all of the plurality of jobs 210 are CMYK color or all of them are CMYK +alpha color, the rule setting 400 is not generated for this.

Further, the rule generation unit 120 may generate rule setting 400 based on the paper, ink, resolution, ICC profile, commercial library for color designation, presence or absence of a font, processing capability when RIP, image enhancement, presence or absence of processing such as skew correction, or the like, presence or absence of plug-ins, or the like, specified in the plurality of jobs 210.

Further, the rule generation unit 120 may also generate rule setting 400 based on whether or not a particular post-processing is specified.

Furthermore, the rule generation unit 120 can also generate a rule setting 400 that combines the rules set in the rule setting 400. For example, the rule generation unit 120 can generate the rule setting 400 that includes the rule grouped by color printing or monochrome printing in addition to the rule for paper type.

Step S102

Then, the group management unit 110 determines whether to start the simulation or not. The group management unit 110 refers to the condition setting 410 to determine whether the set time, set interval, or number of acquired jobs 210 has reached the set value of the condition for starting the simulation. If the set value of the condition has been reached, the group management unit 110 determines Yes. Otherwise, the group management unit 110 determines No.

In the case of Yes, the group management unit 110 proceeds to step S103.

In the case of No, the group management unit 110 proceeds to step S104.

Step S103

When starting simulation, the group management unit 110 performs the simulation process.

In the present embodiment, the group management unit 110 generates a group job 230 by grouping 210 a plurality of jobs to be grouped according to the generation rule 220 and then performs simulation to allocate the group job 230 to the available space in the schedule setting 200.

Specifically, at first, the group management unit 110 generates the group job 230 based on the rule setting 400 in the generation rule 220 for the jobs 210 stored in the storage unit 19 at that time.

Thereafter, the group management unit 110 schedules the generated group job 230. In other words, it simulates the allocation of the generated group job 230 to an available schedule in the schedule setting 200.

Here, the group management unit 110 refers to the condition setting 410 and performs a simulation of the allocation of the jobs 210 depending on whether priority settings 320 of the jobs 210 are applied, prioritized, or not applied.

The group management unit 110 analyzes each of the jobs 210 based on the rule setting 400 of the generation rule 220 to determine the processing requirements. In this time, the group management unit 110 determines whether each of the jobs 210 matches the rule setting 400 based on the job information 300, delivery date information 310, the priority setting 320, the job ticket 330, the print data 340, and the print resources 350 included therein. Then, the matched jobs 210 are set to be allocated to the group job 230.

At this time, when the priority setting 320 of the jobs 210 is applied or prioritized, the group management unit 110 performs a simulation based on which of the delivery date and cost of each of the jobs 210 is prioritized. Specifically, in the case of a job 210 for which priority is given to the delivery date in the priority setting 320, the group management unit 110 allocates the generated group job 230 to an available schedule in the schedule setting 200 so that the group job 230 can be processed as quickly as possible. At this time, the group management unit 110 also refers to the reservation information in the priority setting 320 so that it can be assigned to the set component apparatus.

Alternatively, in the case of jobs 210 set to prioritize cost in the priority setting 320, the group management unit 110 allocates them to a free schedule that has “space” where the most jobs 210 can be processed, while also referring to the delivery date information 310. In such case, if the priority setting 320 of the jobs 210 is “applied,” the group management unit 110 performs the allocation described above based on this setting value. However, if the priority setting 320 of the jobs 210 is “prioritized,” the group management unit 110 performs allocation in a manner that does not necessarily follow the set values so that the combination is optimized. Here, although the group management unit 110 ensures that priority is assigned to the component apparatus set in the reservation information for the priority setting 320, it does not necessarily have to be assigned to that apparatus.

Alternatively, if the condition setting 410 is “not applied,” group management unit 110 may make allocations as appropriate according to the delivery date information 310 of the jobs 210 without referring to the priority setting 320 of the jobs 210.

Here, when group job 230 is assigned to schedule setting 200, the group management unit 110 may calculate the estimated processing completion time of each the jobs 210 and set it in the delivery date information 310. This estimated processing completion time may be calculated based on information about the processing capabilities and status of the component apparatuses in the schedule setup 200. For example, the group management unit 110 may calculate the estimated processing completion time based on the available space in the allocated schedule setting 200 and the expected processing time. Furthermore, the group management unit 110 may calculate the estimated processing completion time for that group job 230 and set it to that group job 230.

More specifically, the group management unit 110 may calculate the processing time of each of the jobs 210 from the number of printed pages of that job 210 and the average throughput (Pages Per Minutes) of each component apparatus in the group, or the like. Furthermore, the group management unit 110 may calculate costs other than processing time, such as the amount of consumables, in the same manner.

Furthermore, the group management unit 110 may present the group job 230 itself as an error if there is a job 210 that exceeds the delivery date and time in the delivery date and time information 310 when assigning each of the jobs 210 in the group job 230.

The group management unit 110 stores the output of these simulations in the simulation result 430.

Here, the group management unit 110 may send the simulation result 430 to the dedicated application on the management terminal 6.

The GUI of the dedicated application of the management terminal 6 can display the simulation result 430 including the processing cost of the group job 230, the processing time, the amount of consumables, other costs, and the like. In other words, on the GUI, the user can check the simulation result 430 when the jobs 210 are grouped together by the rule setting 400, and he or she can instruct to modify or select the generation rule 220.

Note that the group management unit 110 may perform simulations with the set values of the conditions set by the user, repeatedly. In other words, repeated simulations can be performed and a group job 230 can be allocated optimally when there is an available space.

Step S104

Then, the processing management unit 130 performs the job accumulation process.

The processing management unit 130 acquires a plurality of jobs 210 from the management terminal 6, the inter-site management system that is upstream of the industrial printing system X, other terminals of users, prepress equipment, or the like, and stores them sequentially in the storage unit 19. Each of these the plurality of jobs 210 may be created by the management terminal 6 for a manuscript submitted by a submission terminal.

Step S105

Then, the processing management unit 130 determines whether the condition for starting the group job execution is fulfilled or not. The processing management unit 130 refers to the threshold setting 420 and reads the estimated processing completion time set by the simulation in the delivery date information 310 of each of the jobs 210 stored in the storage unit 19. On this basis, if the threshold condition of threshold setting 420 is “the earliest time among the estimated processing completion time exceeds the threshold date and time for the first time,” the processing management unit 130 determines Yes if the earliest time in the estimated processing completion time of all the jobs 210 exceeds the threshold date and time. On the other hand, if “the latest time among the estimated processing completion times exceeds the threshold date and time for the first time,” the processing management unit 130 determines Yes if the latest time among the estimated processing completion times of all the jobs 210 exceeds the threshold date and time. Otherwise, the processing management unit 130 determines No.

In the case of Yes, the processing management unit 130 proceeds to step S106.

In the case of No, the processing management unit 130 returns the processing to step S102 and continues the simulation.

Step S106

If the condition for starting group job execution is fulfilled, the processing management unit 130 performs group job execution process.

The processing management unit 130 causes the corresponding component apparatus to process the generated group job 230 according to the results of the simulation by the group management unit 110.

Specifically, the group management unit 110 combines the plurality of selected jobs 210 into a group job 230 according to the generation rule 220 selected according to the simulation result 430 as described above. The processing management unit 130 selects each of the jobs 210 stored in the storage unit 19 to group as a group job 230 based on the generation rule 220 and allocates it to the available schedule information. In other words, as similar to the simulation described above, the group job 230 is actually generated and processed to each component apparatus based on the generation rule 220 and the delivery date information 310 of each the jobs 210, or the like.

FIG. 7 shows an example of allocating and executing a group job 230 to the available space in the schedule setting 200 on printing apparatuses 2-1 to 2-n.

This process starts the printing process, and the rasterization process, printing process, and post-processing of the jobs 210 are executed at the component apparatuses set for group job 230. The processing management unit 130 may send processing status notifications and completion notifications for the group job 230 and each of its jobs 210 to the management terminal 6 before and after this processing request and processing completion. In other words, the processing management unit 130 can manage the processing status and the completion of processing.

This concludes the group allocation process.

As configured in this way, the following effects can be obtained.

In a typical production printing system, for the purpose of efficiently processing a large number of print jobs, jobs with the same setting, or the like, has been sometimes collected and grouped together and processed together. However, depending on how the jobs are grouped and when the grouped jobs are printed and processed, they have not always processed efficiently, and in some cases the grouping resulted in inefficiency.

On the other hand, the industrial printing system X in the present embodiment is an industrial printing system that performs production printing, including: a schedule management unit 100 that centrally manages schedule setting 200 for processing jobs 210 on component apparatuses; a group management unit 110 that generates a group job 230 by grouping jobs 210 in accordance with a generation rule 220 that indicates how to group jobs 210 and performs a simulation of allocating the group job 230 to an available space in the schedule setting 200 managed by the schedule management unit 100; and a processing management unit 130 that causes a corresponding component apparatus to process the group job 230 generated according to result of the simulation performed by the group management unit 110.

This configuration allows a workflow system that manages the plurality of component apparatuses to flexibly group jobs 210 and start processing them according to the work schedule of each component apparatus, thereby making the entire production printing process more efficient. That is, in a workflow system that manages a plurality of component apparatuses, the jobs 210 can be processed efficiently by generating the group job 230 according to the scheduling status of the jobs 210 in each component apparatuses. The result is more efficient processing than typical techniques. In addition, it is possible to build an autonomous or automated system in which the management server determines the processing status of component apparatuses and processes them.

The industrial printing system X according to the present embodiment further includes a rule generation unit 120 that generates generation rule 220 based on either or both the processing capacity and status of the component apparatus.

By configuring in this way, the optimal generation rule 220 can be selected for efficient processing. In other words, jobs 210 can be grouped together as a group job 230, taking into account the processing capacity and configuration state of the component apparatus. Thus, efficient processing of group job 230 can be performed. Further, set changes, such as changing paper sets during printing, can be minimized. Therefore, printing operations can be made more efficient.

In the industrial printing system X according to the present embodiment, the jobs 210 includes delivery date information 310, and group management unit 110 performs simulation based on the condition of whether priority is given to delivery date information 310 or cost, and the threshold value of the completion processing time of group job 230.

By configuring in this way, the group job 230 can be generated and processed based on the delivery date or cost set for the jobs 210 itself. Moreover, the simulation based on the set threshold for completion of the group job 230 can be used to generate and process the appropriate group job 230 in accordance with the user’s intention.

In the industrial printing system X, the processing management unit 130 starts the simulation when the set time, set interval, or number of jobs 210 obtained reaches a set value of the condition.

By configuring in this way, the simulation can be started under any condition set by the user. Thus, the simulation can be performed to summarize the jobs 210 at the appropriate timing in the user’s environment, resulting in efficient processing of the jobs 210 being made.

In the industrial printing system X of the present embodiment, the jobs 210 includes a priority setting 320 to prioritize either delivery date or cost, and the group management unit 110 performs simulation based on the priority setting 320 of the jobs 210.

By configuring in this way, the jobs 210 can be grouped together as a group job 230 based on the priority setting 320 set in the jobs 210 itself. In other words, the group job 230 can be generated according to the nature of the jobs 210. Thus, it is possible to avoid inefficiency due to the grouping of inappropriate jobs 210. As a result, more efficient processing of jobs 210 can be performed at a lower cost.

### Other embodiments

In addition, in the embodiments described above, an example has been described in which a group job 230 is generated by the management server 1 of a workflow system, and the group job 230 is assigned to component apparatuses connected to the management server.

However, the system may be such that a plurality of the management servers 1 are connected peer-to-peer. In this case, it is possible to assign the group job 230 even to component apparatuses of management servers 1 at different locations. In such case, the processing management unit 130 can then forward group jobs 230 to be processed by component apparatuses connected with a different management server 1 than its own management server 1 to that different management server 1.

Alternatively, a management server 1 may be set up to represent each group job 230. This allows the jobs 210, once sent to the management server 1 representing each group job 230, to be forwarded from the representative management server 1 to a different management server 1 at a different location.

For these configurations, the generation rule 220 may allow component apparatuses of management servers 1 at different locations to be set in a group job 230.

Alternatively, the group job 230 may be configured to be flexible and assigned between DFEs of component apparatuses peer-to-peer, without using a management server 1. In such case, for example, a representative printing apparatus 2 may be set up in place of the group’s representative management server 1, and the representative printing apparatus 2 may perform the same processing as the DFE. Furthermore, it may be possible to transfer a job 210 between component apparatuses.

By configuring in this way, the management servers 1, or the like, can be linked peer-to-peer, and group jobs 230 can be assigned to component apparatuses even if they are at different locations. In other words, group jobs 230 can be distributed and processed in an optimal manner. Thus, easily, existing company and other locations can be linked to each other to streamline the execution of group jobs 230. In other words, the entire printing process can be made more efficient by coordinating among the plurality of printing lines.

Also, in the above embodiment, the simulation and the actual allocation of group job 230 are performed separately.

However, if the simulation result 430 is favorable, the group job 230 may be immediately allocated to the available space in the schedule setting 200 and executed, that is, the process may be executed as per the simulation result 430.

This allows for a variety of configurations. Thus, for example, it is possible to flexibly set the generation rule 220, perform simulations, and have the group job 230 processed at the necessary point in time.

Also, in the embodiment described above, an example in which the user sets the generation rule 220 based on the simulation result 430 is described.

However, it is also possible to configure automatically generating the generation rule 220 by using AI, statistical processing, or heuristics based on the history of the execution of group jobs 230 and the nature of the accumulated jobs 210.

This allows group jobs 230 to be processed together without user configuration.

Also, in the above embodiment, an example of combining the rasterization, printing, and post-processing of the jobs 210 into a group job 230 without distinction has been described.

However, separate generation rules 220 may be set for rasterization, printing, and post-processing, and the jobs may be combined into a group job 230.

By configuring in this way, the jobs can be flexibly grouped into group job 230 according to the type and number of component apparatuses in each process.

Also, in the above embodiment, an example of executing group job 230 as it is has been described.

However, it is also possible to change the group job 230 itself according to the status notification, completion notification, error notification, or the like, of each of the jobs 210 in the group job 230.

In this case, it is also possible to change jobs 210 in response to processing change information or alternative setting. In other words, when adjusting processing requests due to delays, it is possible to change the number of pages, color profiles used, or the like, as jobs 210 that can be processed, for example, according to alternative setting. It is also possible to change the job 210 itself selected for the group job 230.

Also, in the embodiment described above, an example in which all the jobs 210 in the generated group job 230 are assigned to the available time of one component apparatus in the schedule setting 200 is described.

However, if there is not enough time to assign to the available space, or if there are too many jobs 210 included in the group job 230, it is possible to split the jobs 210 of the group job 230 and assign them to different available space. In this case, the split group job 230 may or may not be further combined into another group job 230. Furthermore, it is also possible to configure the jobs 210 in the group job 230 to be allocated one by one to the best available space.

This configuration allows for flexible processing even if the jobs 210 are grouped into a group job 230.

Also, in terms used herein, the singular forms “a,” “an,” and “the” include the plural forms unless the context clearly indicates otherwise.

Furthermore, it goes without saying that the configurations and operations of the above-described embodiments are just examples and can be modified as appropriate without departing from the spirit and scope of the present invention.

What is claimed is:

1. An industrial printing system that performs production printing, comprising:
a schedule management unit configured to centrally manage schedule setting for processing jobs on component apparatuses;
a group management unit configured to generate a group job by grouping jobs in accordance with a generation rule that indicates how to group jobs and performs a simulation of allocating the group job to an available space in the schedule setting managed by the schedule management unit; and
a processing management unit configured to cause a corresponding component apparatus to process the group job generated according to result of the simulation performed by the group management unit.

2. The industrial printing system according to claim 1, further comprising:
a rule generation unit configured to generate the generation rule based on either or both the processing capability and status of the component apparatus.

3. The industrial printing system according to claim 1, wherein
the jobs includes delivery date information, and
the group management unit performs the simulation based on a condition of whether priority is given to the delivery date information or cost, and delivery date information in the job.

4. The industrial printing system according to claim 1, wherein
the processing management unit performs the simulation when set time, set interval, or number of obtained jobs reaches a set value.

5. The industrial printing system according to claim 1, wherein
the jobs include a priority setting to prioritize either delivery date or cost, and
the group management unit performs simulation based on the priority setting of the job.

6. A management server that manages jobs for component apparatuses in an industrial printing system that performs production printing, comprising:
a schedule management unit configured to centrally manage schedule setting for processing of jobs on component apparatuses;
a group management unit configured to generate a group job by grouping jobs in accordance with a generation rule that indicates how to group jobs and performs a simulation of allocating the group job to an available space in a schedule setting managed by the schedule management unit; and
a processing management unit configured to cause a corresponding component apparatus to process the group job generated according to result of the simulation performed by the group management unit.

7. The management server according to claim 6, further comprising:
a rule generation unit configured to generate the generation rule based on either or both the processing capability and status of the component apparatus.

8. The management server according to claim 6, wherein
the jobs includes delivery date information, and
the group management unit performs the simulation based on a condition of whether priority is given to the delivery date information or cost, and delivery date information in the job.

9. The management server according to claim 6, wherein
the processing management unit performs the simulation when set time, set interval, or number of obtained jobs reaches a set value.

10. The management server according to claim 6, wherein
the jobs include a priority setting to prioritize either delivery date or cost, and
the group management unit performs simulation based on the priority setting of the job.

11. A processing management method executed by a management server that manages jobs of component apparatuses in an industrial printing system that performs production printing, comprising the steps of:
centrally managing schedule setting for processing of jobs on component apparatuses;
generating a group job by grouping jobs in accordance with a generation rule that indicates how to group jobs;
performing a simulation of allocating the group job to an available space in the managed schedule setting;
causing the corresponding component apparatus to process the generated group job according to the results of the simulation.

12. The processing management method according to claim 11, further comprising a step of:
generating the generation rule based on either or both the processing capability and status of the component apparatus.

13. The processing management method according to claim 11, wherein
the jobs includes delivery date information; and further comprising a step of:
performing the simulation based on a condition of whether priority is given to the delivery date information or cost, and delivery date information in the job.

14. The processing management method according to claim 11, further comprising a step of:
performing the simulation when set time, set interval, or number of obtained jobs reaches a set value.

15. The processing management method according to claim 11, wherein
the jobs include a priority setting to prioritize either delivery date or cost; and further comprising a step of:
performing simulation based on the priority setting of the job.
